(19) United States
(12) Patent Application Publication
(10) Pub. No.: US 2024/0387133 A1
(43) Pub. Date: Nov. 21, 2024

(54) CONTACT PIECE STRUCTURE AND MAGNETIC LATCHING RELAY

(71) Applicant: Xiamen Hongfa Electric Power Controls Co., Ltd., Xiamen (CN)

(72) Inventors: Wenguang DAI, Xiamen (CN); Shuming ZHONG, Xiamen (CN); Fangneng LI, Xiamen (CN); Guojin LIAO, Xiamen (CN)

(21) Appl. No.: 18/668,124

(22) Filed: May 17, 2024

(30) Foreign Application Priority Data
May 18, 2023 (CN) 202310568284.3
May 18, 2023 (CN) 202321212238.1

(51) Int. Cl. H01H 50/54; H01H 51/10

(52) U.S. Cl. CPC H01H 50/54; H01H 51/10

(57) ABSTRACT

A contact piece structure includes two movable contact pieces arranged side by side. Each movable contact piece includes a piece body, a movable contact and a static contact located at opposite ends of the piece body. The movable contact and the static contact of one of the movable contact pieces correspond to the static contact and the movable contact of the other movable contact piece respectively so as to form a parallel circuit structure when the contacts being in contact; Bending portions of two piece bodies are arranged one-to-one to form a bending pair; in each of the bending pairs, top ends of two bending portions are parallel with each other; two bending portions protrude along a same protruding direction, a first distance between the two bending portions is smaller than a second distance between the two ends of two piece bodies.

### CROSS-REFERENCE TO RELATED APPLICATION(S)

This application is based upon and claims priority to Chinese Patent Application No. 202310568284.3 and 202321212238.1, both filed on May 18, 2023, the entire contents thereof are incorporated herein by reference.

### TECHNICAL FIELD

The present disclosure relates to the field of electronic control device technology, specifically to contact piece structure and magnetic latching relay.

### BACKGROUND

A magnetic latching relay is an automatic switch that plays a role of connecting and disconnecting circuits. The magnetic latching relay includes a contact piece structure and a coil. The contact piece structure has at least two contact pieces, in which movable contacts are provided on one of the contact pieces and static contacts are provided on the other of the contact pieces. When the coil is supplied with a forward pulse voltage, the movable contacts and the static contacts are connected, and the circuit is conducted; when the coil is supplied with a reverse pulse voltage, the movable contacts and the static contacts are disconnected, and the circuit is disconnected.

In related art, short circuits are prone to occur in circuits, so it is necessary to improve the ability of the magnetic latching relay to resist short-circuit current, that is, to increase the contact pressure between the movable contact and the static contact to resist the repulsive force generated by the short-circuit current, which makes it difficult for the movable contact and the static contact to disconnect. However, the contact pressure between the movable contact and the static contact is not effectively increased in the related art.

Those contents as disclosed in the Background portion are merely used to reinforce understanding of the background technology of the present disclosure, accordingly the Background portion may include information that does not constitute the related art as already known by an ordinary person skilled in the art.

### SUMMARY

In one aspect of present disclosure, a contact piece structure including two movable contact pieces arranged side by side, each movable contact piece including:
a piece body;
a movable contact and a static contact located at opposite ends of the piece body;
wherein the movable contact and the static contact of one of the movable contact pieces correspond to the static contact and the movable contact of the other movable contact piece respectively, so that when the movable contact and the static contact being in contact, the two movable contact pieces form a parallel circuit structure;
each piece body has at least one bending portion, and bending portions of two piece bodies are arranged one-to-one to form a bending pair; in each of the bending pairs, top ends of two bending portions are parallel with each other, and two bending portions protrude along a same protruding direction, a first distance between the two bending portions is smaller than a second distance between the two ends of two piece bodies.

According to some embodiments of the present disclosure, wherein the two bending portions forming the bending pair are respectively a first bending portion and a second bending portion, at least a portion of the first bending portion is accommodated in a space formed by a protruding portion of the second bending portion.

According to some embodiments of the present disclosure, wherein there are a plurality of bending pairs, and there is a third distance between the two piece bodies located between adjacent bending pairs, and the third distance is greater than the first distance.

According to some embodiments of the present disclosure, wherein the protruding direction includes a first direction and a second direction which are opposite to each other, among the plurality of the bending pairs, a part of the bending pairs protrude toward the first direction, and another part of the bending pairs protrude toward the second direction.

According to some embodiments of the present disclosure, wherein in each of the bending pairs, a size of an opening of the second bending portion is larger than a size of a top end of the first bending portion, so that the top of the first bending portion is accommodated in the opening of the second bending portion.

According to some embodiments of the present disclosure, wherein the shape of each of the bending portions is any one of a trapezoid, a rectangle, a square, a pentagon, a hexagon and an octagon.

According to some embodiments of the present disclosure, wherein each piece body includes a plurality of spring pieces stacked with each other, a gap is formed between adjacent spring pieces.

According to some embodiments of the present disclosure, wherein the piece body has a plurality of gaps in a direction in which the spring piece is stacked, and the sizes of the gaps are different.

According to some embodiments of the present disclosure, further including a bump, the bump being disposed in the gap and connected to at least one spring piece.

According to some embodiments of the present disclosure, wherein the bump is provided in the gap of at least one piece body between adjacent bending pairs.

According to some embodiments of the present disclosure, wherein there are a plurality of bumps, and the plurality of bumps are arranged in the gaps of the plurality of spring pieces of at least one piece body;
wherein in a piece body:
the bumps are aligned in the protruding direction; or,
the bumps are offset in the protruding direction; or,
a part of the bumps are aligned in the protruding direction.

According to some embodiments of the present disclosure, wherein the bumps are respectively provided in the gaps of the plurality of spring pieces of the two piece bodies.

According to some embodiments of the present disclosure, wherein the number of the bumps provided on the two piece bodies is the same or different.

According to some embodiments of the present disclosure, wherein the bumps provided on the two piece bodies are aligned or staggered in the protruding direction.

According to some embodiments of the present disclosure, wherein the bump is provided in the gap of a plurality of spring pieces of one of the piece bodies.

According to some embodiments of the present disclosure, wherein in the protruding direction, the size of the bump is less than or equal to the size of the gap.

In another aspect of present disclosure, a magnetic latching relay including the contact piece structure of present disclosure.

### BRIEF DESCRIPTION OF THE DRAWINGS

The above and other features and advantages of the present disclosure will become more apparent by describing in detail example embodiments thereof with reference to the attached drawings.

FIG. 1 is a front view schematic view of the contact piece structure shown in some embodiments of the present disclosure.

FIG. 2 is a three-dimensional schematic view of the contact piece structure shown in some embodiments of the present disclosure.

FIG. 3 is a three-dimensional schematic view of the contact piece structure from another viewing angle according to some embodiments of the present disclosure.

FIG. 4 is a structural schematic diagram of the movable contact piece in the contact piece structure shown in some embodiments of the present disclosure.

FIG. 5 is an enlarged view of A in FIG. 4.

FIG. 6 is a schematic structural view of another the movable contact piece in the contact piece structure shown in some embodiments of the present disclosure.

FIG. 7 is an enlarged view of B in FIG. 6.

FIG. 8 is an exploded schematic view of the movable contact piece according to some embodiments of the present disclosure.

FIG. 9 is a schematic front view of the contact piece structure with the bump in an embodiment of the present disclosure.

FIG. 10 is an enlarged view of C in FIG. 9.

FIG. 11 is a schematic front view of the contact piece structure according to some embodiments of the present disclosure.

FIG. 12 is an enlarged view of D in FIG. 11.

FIG. 13 is a three-dimensional schematic view of the magnetic latching relay according to some embodiments of the present disclosure.

FIG. 14 is a schematic top view of the magnetic latching relay with the cover removed according to some embodiments of the present disclosure.

FIG. 15 is a schematic view of a three-dimensional structure of the magnetic latching relay with the cover and the fixed frame removed according to some embodiments of the present disclosure.

FIG. 16 is a front view schematic view of the contact piece structure shown in some embodiments of the present disclosure.

FIG. 17 is an enlarged view of E in FIG. 16.

FIG. 18 is a three-dimensional schematic view of the contact piece structure shown in some embodiments of the present disclosure.

FIG. 19 is an exploded schematic view of the movable contact piece according to some embodiments of the present disclosure.

FIG. 20 is a schematic front view of the contact piece structure shown in some other embodiments of the present disclosure.

FIG. 21 is an enlarged view of point F in FIG. 20.

FIG. 22 is a schematic front view of the contact piece structure shown in some other embodiments of the present disclosure.

FIG. 23 is an enlarged view of G in FIG. 22.

FIG. 24 is a schematic front view of the contact piece structure shown in some embodiments of the present disclosure.

FIG. 25 an enlarged view of H in FIG. 24.

FIG. 26 is a three-dimensional schematic view of the magnetic latching relay shown in some embodiments of the present disclosure.

FIG. 27 is a schematic top view of the magnetic latching relay with the cover removed according to some embodiments of the present disclosure.

FIG. 28 is a schematic three-dimensional structural view of the magnetic latching relay without the cover and the fixed frame shown in some embodiments of the present disclosure.

Wherein, the reference numerals are listed as follows:

100. contact piece structure; 1,1′. movable contact piece; 11,11′. piece body; 111. first bending portion; 111′. second bending portion; 112,112′. spring piece; 1121. gap; 12,12′. movable contact; 13,13′. static contact; 14. bump; 141. central line; 151. first movable contact leading-out piece; 152; 16. 16′. the pressure spring; 200. the shell; 21. the base; 22. the cover; 300. the magnetic circuit structure; 31. the coil assembly; 311. the bobbin; 312. the coil; 32. the yoke assembly; 321. the first yoke; 322. the second yoke; 33. the permanent magnet; 331. the rotating shaft; 34. the armature; 400. the push card; 500. the fixed frame; X. the horizontal direction; Y, the protruding direction; Y1. the first direction; Y2. the second direction; d1. the first distance; d2. the second distance; d3. the third distance; h1. size of the bump; h2. size of the gap.

### DETAILED DESCRIPTION

Now, the example implementations will be described more completely with reference to the accompanying drawings. However, the example implementations may be done in various forms and should not be construed as limiting the implementations as set forth herein. Instead, these implementations are provided so that the present disclosure will be thorough and complete, and concept of the exemplary implementation will be fully conveyed to those skilled in the art. Same reference numbers denote the same or similar structures in the figures, and thus the detailed description thereof will be omitted.

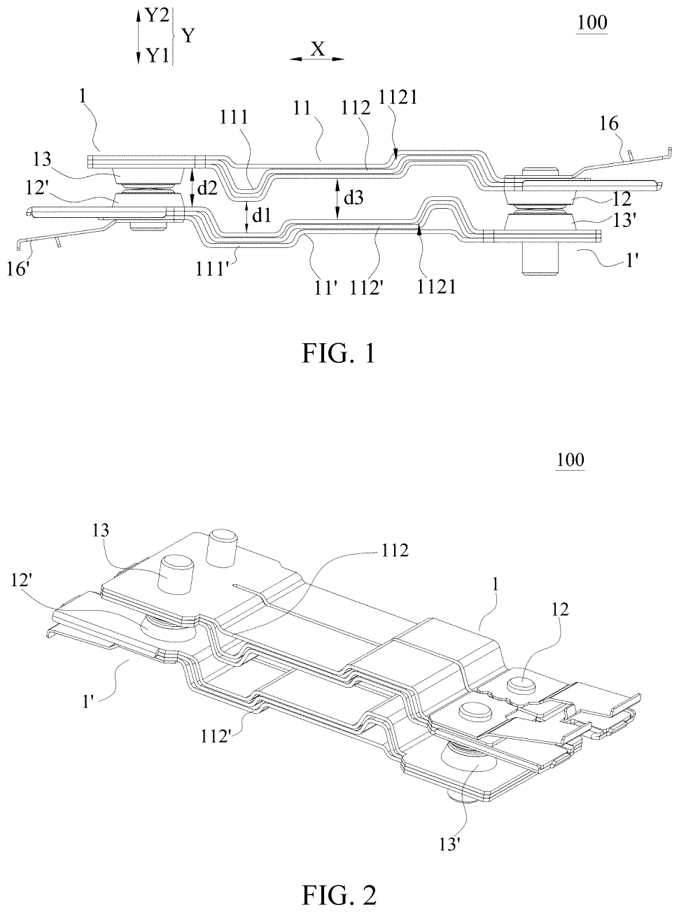

The embodiment of the present disclosure provides a contact piece structure 100. As shown in FIG. 1, the contact piece structure 100 includes: two parallel movable contact pieces 1, 1′. The two movable contact pieces 1, 1′ have the same structure. Each movable contact piece 1, 1′ includes a piece body 11, 11′, a movable contact 12, 12′ and a static contact 13, 13′. Wherein the movable contact 12, 12′ and the static contact 13, 13′ are arranged at opposite ends of the piece body 11, 11′. The movable contact 12 and the static contact 13 of one of the movable contact pieces 1 correspond to the static contact 13′ and the movable contact 12′ of another movable contact piece 1′, respectively, so that when the movable contact 12, 12′ and the static contact 13′, 13 are in contact, the two movable contact pieces 1, 1′ form a parallel circuit structure. Each of the piece bodies 11, 11′ has at least one bending portion, and the bending portions of the two piece bodies 11, 11′ are arranged one-to-one to form a bending pair. In each bending pair, the top ends of the two bending portions are parallel, and the two bending portions protrude along the same protruding direction Y, and the first distance d1 between the two bending portions is smaller than the second distance d2 between the two ends of the two piece bodies 11, 11′.

The contact piece structure 100 of the embodiment of the present disclosure is provided with the bending pair on the piece bodies 11, 11′, and the first distance d1 of the two bending portions in each bending pair is smaller than the second distance d2 of the two ends of the piece bodies 11, 11′, thereby reducing the distance between the two piece bodies 11, 11′. In the parallel circuit structure formed by the two movable contact pieces 1, 1′, the currents attract each other in the same direction to generate electromotive force. Therefore, after reducing the distance between the two piece bodies 11, 11′, the electromotive force of the two piece bodies 11, 11′ can be increased. The top ends of the two bending portions in each bending pair are parallel, thereby reducing the horizontal component of the electromotive force, further increasing the electromotive force of the two piece bodies 11, 11′, thereby effectively increasing the contact pressure of the movable contacts 12, 12′ and the static contacts 13′, 13, making it difficult for the two to be disconnected, thereby effectively resisting short-circuit current.

The contact piece structure 100 of the embodiment of the present disclosure will be described in detail below.

In some embodiments, as shown in FIGS. 1 to 4, the movable contact piece 1 is taken as an example for explanation. The piece body 11 of the movable contact piece 1 includes a plurality of stacked spring pieces 112, and there is a gap 1121 between adjacent spring pieces 112. Wherein the movable contact 12 and the static contact 13 may respectively pass through the two ends of the plurality of stacked spring pieces 112, so that the movable contact 12, 12′ and the static contact 13, 13′ of the two piece bodies 11, 11′ may come to contact each other.

In some embodiments, as shown in FIGS. 1 and 2, the first bending portion 111 is formed by bending the piece body 11, and the first bending portion 111 may protrude along the protruding direction Y. Wherein the protruding direction Y may be understood as the direction perpendicular to the surface of the piece body 11. As shown in FIG. 1, the protruding direction Y includes the opposite first direction Y1 and the second direction Y2. When there is one bending pair, the bending pair may protrude toward the first direction Y1 or the second direction Y2. When there are plurality of bending pairs, the plurality of bending pairs may all protrude in the first direction Y1, or they may all protrude in the second direction Y2, or part of the bending pair protrude in the first direction Y1, and the other part may protrude in the second direction Y2. The bending pair protrudes toward the second direction Y2, and there is no special limitation here. When there are plurality of bending pairs, the protruding direction Y of the plurality of bending pairs may not be the same, as shown in FIG. 1. The protruding direction Y of the bending pairs located on the left and right sides of FIG. 1 are different. The protruding direction Y of the bending pair located on the left side is the first direction Y1, and the protruding direction Y of the bending pair on the right is the second direction Y2. Therefore, the protruding direction of the bending pair described in the embodiment of the present disclosure Y refers to the protruding direction of the bending pair. For example, the protruding direction Y of the bending pair on the left is the first direction Y1, not the second direction Y2.

As shown in FIG. 4, since the piece body 11 includes a plurality of stacked spring pieces 112, the opening size of the bending portion of each spring piece 112 may be different. The opening size may be understood as the size of the opening of the bending portion in the horizontal direction X. The horizontal direction X may be defined as the extension direction of the spring piece 112, which is perpendicular to the protruding direction Y.

In some embodiments, in the protruding direction Y, at least a portion of the first bending portion 111 is accommodated in a space formed by a protruding portion of the second bending portion 111′ (not shown in the figure), so that the first distance d1 between the two portions is smaller than the second distance d2 between both ends of the piece bodies 11, 11′, in each bending pair.

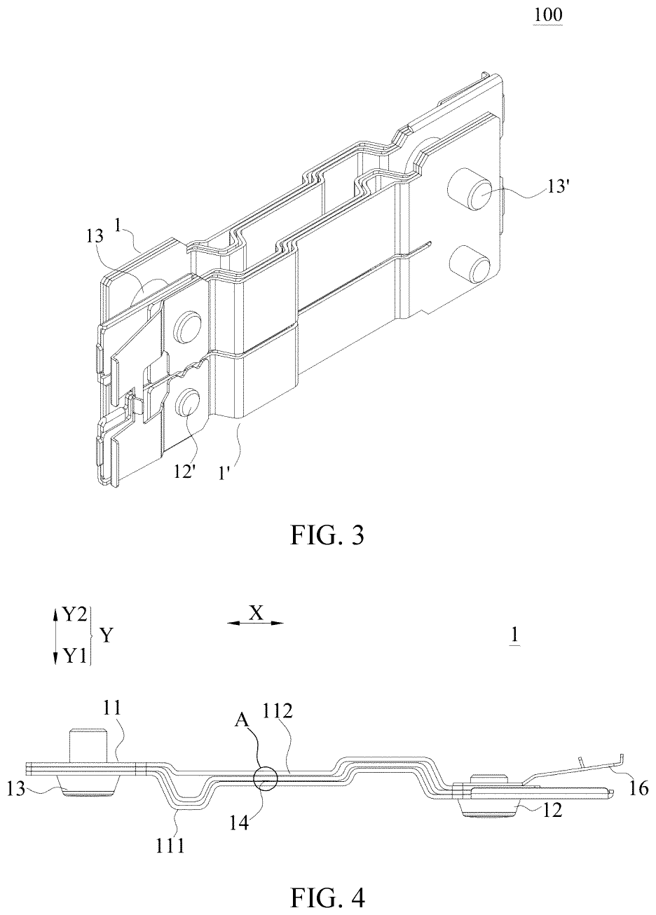

In some embodiments, as shown in FIGS. 3 and 4, in the piece body 11, each of the plurality of stacked spring pieces 112 has one sub-bending portion, and the plurality of sub-bending portions have openings along the protruding direction Y. The size gradually increases. A plurality of sub-bending portions jointly forms the bending portion of the piece body 11.

In some embodiments, as shown in FIG. 1, in each bending pair, the size of the opening of the second bending portion 111′ is larger than the size of the top of the first bending portion 111, so that the top of the first bending portion 111 may accommodate in the opening of the second bending portion 111′.

Specifically, the size of the opening of the bending portion refers to the size of the opening of the bending portion along the horizontal direction X, and the size of the top of the bending portion refers to the maximum size of the top of the bending portion in the horizontal direction X. In this way, the top end of the first bending portion 111 may be accommodated in the opening located in the second bending portion 111′, thereby reducing the first distance d1 of the two bending portions in the bending pair. The first distance d1 may be understood as the distance between the top end of the first bending portion 111 and the bottom end of the second bending portion 111′ in the bending pair. Wherein, the top end of the first bending portion 111 refers to the top end of the protruding portion, and the bottom end of the second bending portion 111′ refers to the portion of the protruding portion closest to the first bending portion 111. Therefore, the first distance d1 is shortened compared to the second distance d2 at both ends of the two piece bodies 11, 11′. Wherein the second distance d2 of the two ends of the two piece bodies 11, 11′ may be understood as the distance between the two ends of the piece body 11, 11′ having the movable contact 12, 12′ and the static contact 13, 13′.

When the two movable contact pieces 1, 1′ are energized, the movable contact 12 and the static contact 13′ are attracted, the movable contact 12′ and the static contact 13 are attracted, and the two movable contact pieces 1, 1′ form a parallel circuit, and the current flowing through the two piece bodies 11 and 11′ have the same direction. According to the principle of current attracting in the same direction, the two piece bodies 11 and 11′ will definitely attract each other, and the first distance d1 between the two piece bodies 11 and 11′ at the bending portion will be reduced. The electromotive force of mutual attraction between the piece body 11, 11′ can be increased. At the same time, the bending portion may increase the effective length of the piece body 11, 11′, thus the contact pressure between the movable contact 12, 12′ and the static contact 13′, 13 may be increased and prevents the movable contact 12, 12′ and the static contact 13′, 13 from being disconnected when subjected to the repulsive force of the short-circuit current, which may resist the short-circuit current and ensure the stability of the circuit operation.

In fact, the electromotive force is formed by the Ampere force (Lorentz force). The two movable contact pieces 1 and 1′ may be regarded as two parallel wires. When the movable contact pieces 1 and 1′ are energized, the two piece bodies 11 and 11′ generate a magnetic field around them. Due to the flow of current and the effect of the magnetic field, one of the piece bodies 11 is subjected to the Ampere force of the other piece body 11′, so that the two piece bodies 11 and 11′ attract each other. The mutual attraction between the two may increase the contact pressure between the movable contacts 12 and 12′ and the static contacts 13′ and 13 at both ends, making the two more firmly attracted.

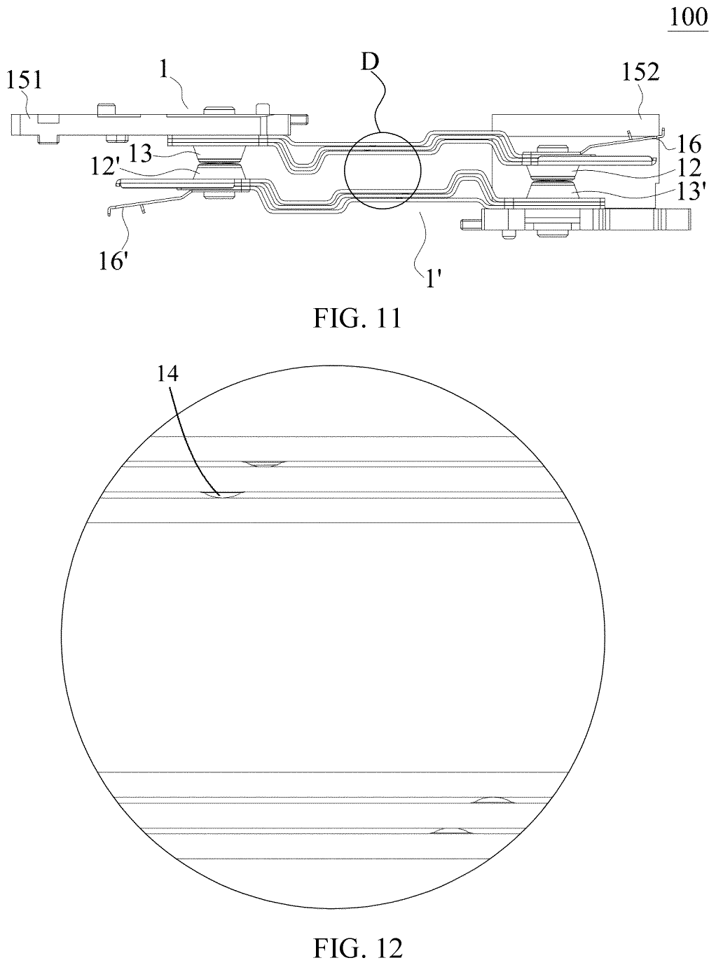

However, in some embodiments, taking the movable contact piece 1 as an example, the spring piece 112 of the piece body 11 has a certain flexibility, that is, the spring piece 112 has low rigidity. This because when the movable contact piece 112 is pushed to make electrical contact between the movable contact 12 and the static contact 13′ of the other piece body 11′, the spring piece 112 has a certain elasticity that allows it to overtravel, thereby making the contact between the movable contact 12 and the static contact 13′ of the other piece body 11′ more stable and difficult to be bounced off. However, it is precisely because the spring piece 112 has a certain flexibility that when the spring piece 112 is subjected to electric force, the spring piece 112 will use its middle part as a fulcrum to bend in the direction in which the other spring piece 112′ is approaching. A large amount of deformation in the middle part will cause the parts at both ends of the spring piece 112 to warp up in opposite directions. As shown in FIG. 11 and FIG. 14, the movable contact piece 1, 1′ of the contact piece structure 100 also includes a pressure spring 16, 16′, taking the movable contact piece 1 as an example, one end of the pressure spring 16 is connected to the movable contact 12, and the other end is used to connect the push card 400 of the magnetic latching relay. If two ends of the spring piece 112 are warped up, that is, the two ends of the movable contact piece 1 are warped up, which will drive the pressure spring 16 to move, and the movement of the pressure spring 16 will drive the push card 400 to move, making the entire magnetic latching relay in an unstable state, which may affect the electrical performance of the magnetic latching relay. In order to avoid the above situation, in the embodiment of the present disclosure, when the number of the bending pairs is set to multiple, the two piece bodies 11 and 11′ located between the adjacent bending pairs have a third distance d3, the third distance d3 is greater than the first distance d1.

That is to say, the distance between the straight parts of the two piece bodies 11, 11′ between two adjacent bending pairs may be greater than the distance between the two bending portions in a bending pair, so, the electric force received by the straight part is smaller than the electric force received by the bending portion, and greater than the electric force received by two ends of the movable contact 12, 12′ and the static contact 13, 13 are provided of the piece body 11, 11′, which reduces the amount of deformation and prevents two ends of the piece body 11, 11′ from being warped up due to excessive deformation. At the same time, since there is a gap 1121 between the plurality of spring pieces 112 of the piece body 11, in the piece body 11, the deformations of the spring pieces 112 will not affect each other, that is, they will not overlap each other, further avoid the situation that the deformation of the whole piece body 11 is too large to affect the contact pressure between the movable contact 12 and the static contact 13′. The situation of the piece body 11′ is the same as that of the piece body 11 and will not be described again here.

In some embodiments, the third distance d3 between the straight parts of the two piece bodies 11, 11′ located between two adjacent bending pairs may also be less than or equal to the second distance d2 between the two ends of the two piece bodies 11, 11′ (the two ends at which the movable contacts 12, 12′ and the static contacts 13, 13′ are provided), so that the electric force exerted on the straight part may be applied to the movable contacts 12, 12 and the static contacts 13′, 13 to increase the contact pressure therebetween.

In some embodiments, when the flexibility of the spring piece 112, 112′ is relatively large, the third distance d3 between the straight portions of the two piece bodies 11, 11′ located between two adjacent bending pairs may also be greater than the second distance d2 between the two ends of the two piece bodies 11, 11′ (the two ends of the movable contact 12, 12′ and the static contact 13, 13′ are provided) to further prevent the spring piece 112, 112′ from deforming too much when subjected to electric force, thereby causing the two ends of the spring piece 112, 112′ to warp up.

In some embodiments, the shape of the bending portion may be any one of a trapezoid, a rectangle, a square and other polygon. As shown in FIG. 1, in the embodiment of the present disclosure, the bending portion of the piece body 11, 11′ is a trapezoid, and the top ends of the plurality of bending portions extend along the horizontal direction X, that is, the top ends of the plurality of bending portions are parallel, so that the electric forces received by the two bending portions are respectively perpendicular to themselves, and no oblique electric forces are generated, thereby reducing the component of the electric forces along the horizontal direction X and increasing the electric forces received by each piece body 11, 11′. Continuing to refer to FIG. 1, the side walls of the plurality of bending portions may also be parallel to each other, so that the force of attraction between the two piece bodies 11, 11′ reaches the maximum, further increasing the electric forces.

In some embodiments, the bending portion may also be in the shape of a rectangle, a square or other polygon, and the polygons may be pentagons, hexagons, octagons, etc., as long as the top ends of the two bending portions in each bending pair are parallel to each other.

In some embodiments, adjacent bending pairs have different shapes. For example, the two bending portions in the first bending pair are trapezoidal in shape, the two bending portions in the second bending pair adjacent are both square, and the shapes in the third bending pair adjacent are both square. The two bending portions are both rectangles, and the two bending portions in the adjacent fourth bending pair are both polygons.

In some embodiments, the shape of the bending portion in each bending pair may also be different from each other. For example, the first bending portion 111 in a bending pair is a trapezoid, and the second bending portion 111′ is a square; the first bending portion 111 in a bending pair is a rectangle, and the second bending portion 111′ is a pentagon. Regardless of whether the shapes of the bending portions in the bending pair are the same or different, their top ends are parallel to each other, and those skilled in the art may select them according to actual conditions, and no special limitation is made here.

In some embodiments, the top end of the bending portion and the two side walls are in an arc-shaped transition to facilitate manufacturing and increase the service life of the spring pieces 112, 112′.

In some embodiments, as shown in FIG. 1, taking the piece body 11 as an example, there are a plurality of gaps 1121 in the stacking direction thereof, and the sizes of the plurality of gaps 1121 are different. That is, the sizes of the plurality of the gaps 1121 in the protruding direction Y are different.

Specifically, as shown in FIG. 1, the piece body 11 is taken as an example for explanation. The gap 1121 between the plurality of the spring pieces 112 of the piece body 11 is located between the two ends of the piece body 11 provided with the movable contact 12 and the static contact 13. The gap 1121 is formed between the adjacent sub-bending portions, so the size of the gap 1121 may be determined according to the bending degree of sub-the bending portion. Therefore, the contact piece structure 100 of the embodiment of the present disclosure may flexibly adjust the size of the gap 1121 between each of the spring pieces 112. The bending degree may be understood as the size from the top wall of the bending portion to the opening along the protruding direction Y. By providing the gap 1121 between the plurality of the spring pieces 112, when each of the spring pieces 112 is deformed by the electric force, the deformation of each of the spring pieces 112 will not affect others, thereby ensuring the stability of the electric force received. In addition, according to the magnitude of the short-circuit current, the magnitude of the electromotive force applied to the spring pieces 112, 112′ may be flexibly adjusted by changing the number of the bending pairs, the bending degree of the bending portions, or the first distance d1 between the bending portions in each bending pair.

In some embodiments, as shown in FIGS. 4 to 12, the contact piece structure 100 further includes bumps 14, which are disposed in the gap 1121 and connected to at least one of the spring pieces 112, 112′. The bumps 14 are disposed in the gap 1121. When the spring pieces 112 and 112′ are deformed by the electric force, the bumps 14 may resist the deformed parts of the spring pieces 112 and 112′, and that is to say, the bumps 14 may reduce the deformation amount of the spring piece 112, 112′. When the spring piece 112, 112′ is flexible, the bumps 14 may prevent the deformation amount of the spring piece 112, 112′ from being too large. As a result, the two ends of the spring piece 112, 112′ are partially warped up, thereby ensuring the stability of the contact pressure between the movable contact 12, 12′ and the static contact 13′, 13, and preventing the movable contact 12, 12′ and the static contact 13′, 13 are disconnected when subjected to the repulsive force generated by the short-circuit current.

Wherein the bumps 14 may be connected to the spring piece 112 (taking the spring piece 112 as an example) by welding, screwing or gluing. One side of the bumps 14 may be connected to a spring piece 112. Alternatively, the opposite sides of the bumps 14 may be connected to two adjacent upper and lower spring pieces 112, or the bumps 14 and the spring piece 112 may be integrally formed. The material of the bumps 14 may be the same or different from the material of the spring piece 112. The bumps 14 may be made of conductive metal or insulating material. In addition, the bumps 14 may have greater rigidity and may play a greater role in resisting the deformed spring piece 112 and prevent it from deforming. Of course, the bumps 14 may have a certain degree of flexibility. When the spring piece 112 is deformed by electric force, the bumps 14 may play a buffering role when it abuts against another spring piece 112, extending service life of the spring piece 112. The relationship between the bumps 14 and the spring piece 112′ is the same as above and will not be repeated here.

Regarding the connection method and properties of the bumps 14, those skilled in the art may select according to actual conditions, and no special limitation is made here.

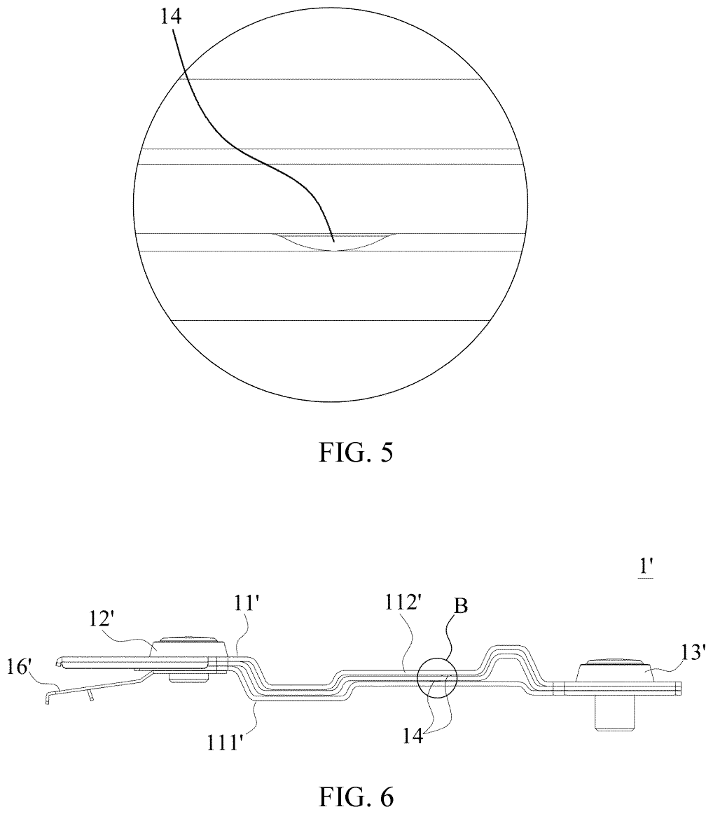

In some embodiments, as shown in FIGS. 5, 7, 10 and 12, the bumps 14 are provided in the gap 1121 of at least one of the piece bodies 11, 11′ between the adjacent bending pairs. That is to say, the bumps 14 are provided in the gap 1121 of the spring pieces 112, 112′ in the straight portion between the adjacent bending pairs. Based on the above embodiment, the spring piece 112 is still taken as an example. When the spring piece 112 has flexibility, the spring piece 112 is deformed by electric force and is located at the straight portion between the adjacent bending pairs. The deformation is large. By arranging the bumps 14 in the gap 1121 between of the straight parts of the spring pieces 112, this deformation may be reduced to as large as possible, that is, the deformation due to the large deformation of the straight part, which causes two ends of the piece body 11 to warp up, is avoided, thereby ensuring the stability of the contact pressure between the movable contact 12 and the static contact 13′ of the other piece body 11′.

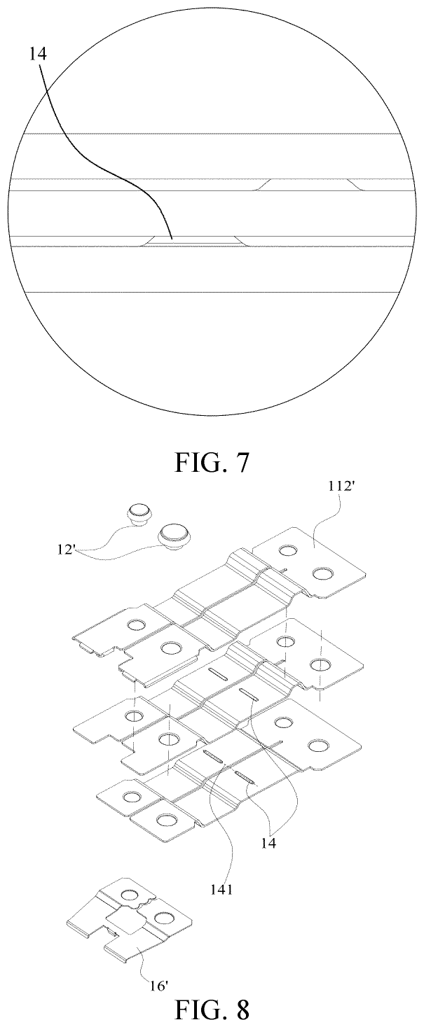

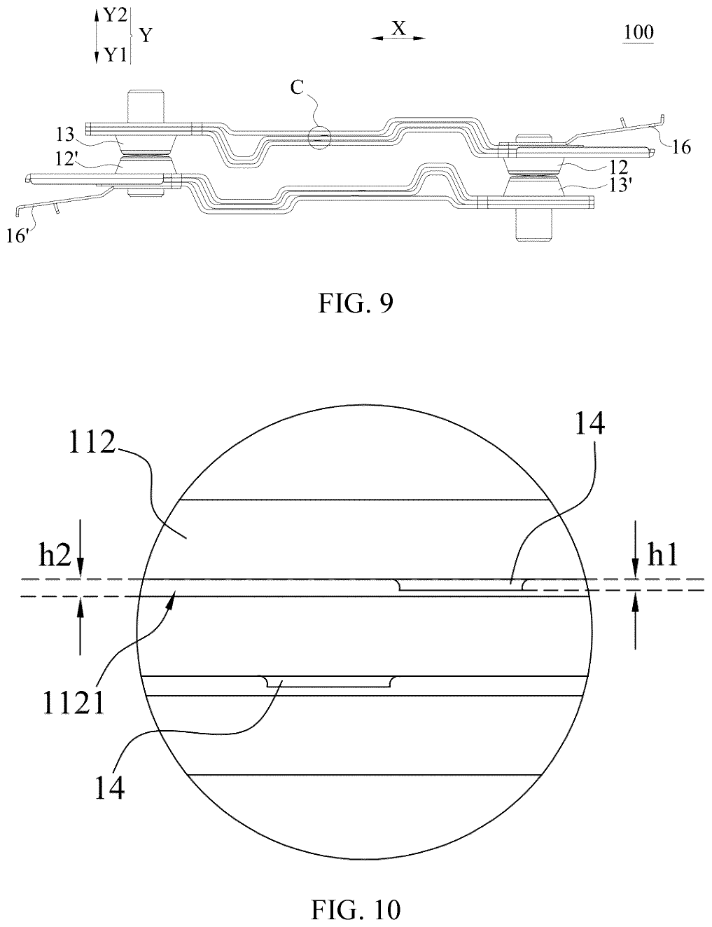

In some embodiments, as shown in FIG. 6 and FIG. 7, there are a plurality of bumps 14, and the plurality of bumps 14 are arranged in the gap 1121 of the spring piece 112, 112′ of at least one of the piece body 11, 11′. In one of the piece bodies 11, the bumps 14 are aligned in the protruding direction Y, or the bumps 14 are staggered in the protruding direction Y, or part of the bumps 14 are aligned in the protruding direction Y, and another part of the bumps 14 are staggered in the protruding direction Y.

Wherein the plurality of bumps 14 may be aligned in the protruding direction Y, which may be understood that in the extension direction of the bump 14, the central line 141 of the bump 14 is aligned in the protruding direction Y. When the spring pieces 112, 112′ have high flexibility, as shown in FIG. 9, the plurality of bumps 14 may be provided in each of the gaps 1121 of the plurality of spring pieces 112, 112′, and are located at the portion that are easily deformed (such as the straight part between two adjacent bending pairs). The bump 14′ is aligned in the protruding direction Y may minimize the deformation of this part. When the piece body 11, 11′ has less flexibility, the plurality of bumps 14 may be disposed in one gap 1121, and the plurality of bumps 14 are disposed along the horizontal direction X in one gap 1121, that is, the plurality of bumps 14 are staggered in the protruding direction Y, thus, the spring pieces 112, 112′ may be deformed evenly or not deformed when receiving electric force. Taking the spring piece 112 as an example, according to the deformation of the spring piece 112, the plurality of bumps 14 may also be disposed in plurality of gaps 1121 of each spring piece 112, and the plurality of bumps 14 may be disposed in each gap 1121. A bump of 14 may be disposed by those skilled in the art according to the actual situation, and there is no special limitation here.

Of course, in order to save costs and simplify the manufacturing process, when the number and setting position of the bumps 14 meet the deformation requirements of the spring piece 112, the fewer the number of the bumps 14, the better.

In some embodiments, as shown in FIGS. 8 and 9, the bumps 14 are provided on gaps 1121 of the plurality of spring pieces 112, 112′ of two piece bodies 11, 11′.

Based on the above embodiments, the bump 14 may be disposed in the gaps 1121 of the plurality of the spring pieces 112, 112′ of the piece bodies 11, 11′ of the two movable contact pieces 1, 1′. In some embodiments, the number of the bump 14 disposed in the two piece bodies 11, 11′ is the same or different, and the positions of the bumps 14 of the two piece bodies 11, 11′ may be the same or different. In some embodiments, in order to simplify the manufacturing process, the number and positions of the bumps 14 set disposed in two piece bodies 11, 11′ are the same. Those skilled in the art may set it according to actual conditions, and no special limitation is made here.

In some embodiments, the bumps 14 provided on two piece bodies 11, 11′ are aligned or staggered in the protruding direction Y. The central line 141 of the bump 14 located in the two piece bodies 11, 11′ may be aligned in the protruding direction Y, or may be staggered. Persons skilled in the art may set it according to the actual situation of the spring pieces 112, 112′, no special restrictions are made here.

In some embodiments, the bumps 14 are only provided in the gaps 1121 of the plurality of the spring pieces 112, 112′ of one of the piece bodies 11, 11′. As shown in FIGS. 4 to 7, the bumps 14 may be provided in only one of the piece bodies 11. For example, the spring piece 112 of the piece body 11 has greater flexibility, and by providing the bump 14, it may be prevented from having a greater amount of deformation.

In some embodiments, the dimension h1 of the bump 14 is less than or equal to the dimension h2 of the gap 1121 in the protruding direction Y.

Specifically, as shown in FIG. 10, in the protruding direction Y, the size h1 of the bump 14 is smaller than the size h2 of the gap 1121. Taking the spring piece 112 as an example, one side of the bump 14 is connected to the spring piece 112, and the other side has a gap with the adjacent spring piece 112. When the spring piece 112 is subjected to electric force, the bump 14 does not immediately press against the other spring piece 112, but allows the spring piece 112 to have a certain amount of deformation before preventing deformation. In this case, the spring piece 112 may have an overtravel, thereby increasing the contact pressure between the movable contact 12 and the static contact 13′ of the other piece body 11′. According to the deformation ability of the spring piece 112, the size h1 of the bump 14 in the protruding direction Y may be appropriately adjusted, and then the size of the gap between the bump 14 and the adjacent spring piece 112 may be adjusted, so as to flexibly adjust the deformation of the spring piece 112 so that the contact pressure between the movable contact 12 and the static contact 13′ reaches the most appropriate value. The specific size of the bump 14 in the protruding direction Y may be set according to actual conditions, such as the deformation of the spring piece 112, the size of the short-circuit current, etc., and is not specifically limited here.

Therefore, according to the magnitude of the short-circuit current, the size, quantity, position, etc. of the bump 14 may be changed, and the magnitude of the electric force applied to the spring piece 112, 112′ may be flexibly adjusted to avoid the contact pressure between the movable contact 12, 12′ and the static contact 13′, 13 being too large or too small.

In some embodiments, as shown in FIG. 11, each of the movable contact pieces 1 in the contact piece structure 100 further includes a first movable contact leading-out piece 151 and a second movable contact leading-out piece 152. One end of the first movable contact leading-out piece 151 is connected to the static contact 13, and the other end is used for connecting to an external load. One end of the second movable contact leading-out piece 152 is connected to the static contact 13′, and the other end is used to connect to an external load.

To sum up, in the contact piece structure 100 of the embodiments of the present disclosure, the bending pair is provided on the piece bodies 11 and 11′, and the first distance d1 of the two bending portions in each bending pair is smaller than the two piece bodies. The second distance d2 at both ends of 11 and 11′ reduces the distance between the two piece bodies 11 and 11′. In the parallel circuit structure formed by the two movable contact pieces 1 and 1′, the current flows in the same direction. The mutual attraction generates electric force, so when the distance between the two piece bodies 11, 11′ is reduced, the electric force of the two piece bodies 11, 11′ may be increased; At the same time, in each bending pair, The top ends of the two bending portions are parallel, reducing the horizontal component of the electric force; the bending portion may increase the effective length of the piece body 11, 11′, further increasing the electric force of the two piece bodies 11, 11′, and further effectively increasing the contact pressure between the movable contact 12, 12′ and the static contact 13′, 13, making them difficult to disconnect and effectively resisting short-circuit current.

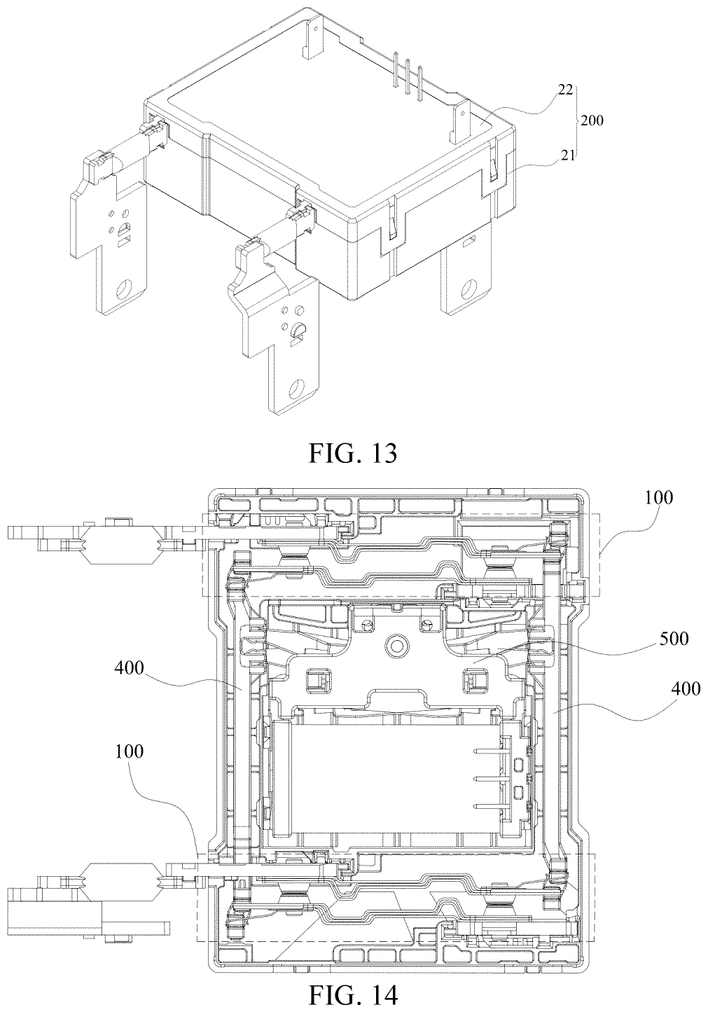

As shown in FIGS. 13 to 15, the embodiment of the present disclosure also provides a magnetic latching relay including a shell 200 and at least one contact piece structure 100 described in any of the above embodiments, a magnetic circuit structure 300, a push card 400 and a fixed frame 500.

As shown in FIGS. 13 to 15, the shell 200 includes a base 21 and a cover 22. The contact piece structure 100 and the magnetic circuit structure 300 are both mounted on the base 21, the fixed frame 500 is mounted on the magnetic circuit structure 300, and the cover 22 is covered, so that the contact piece structure 100, the magnetic circuit structure 300, the push card 400 and the fixed frame 500 may be accommodated in the shell 200.

In some embodiments, the magnetic circuit structure 300 includes a coil assembly 31, a yoke assembly 32, a rotating permanent magnet 33 and an armature 34. The coil assembly 31 includes a bobbin 311 and a coil 312, and the coil 312 is wound around the bobbin 311. The yoke assembly 32 includes a first yoke 321 and a second yoke 322. The first yoke 321 and the second yoke 322 are located on both sides of the bobbin 311 in the axial direction, and the first yoke 321 and the second yoke 322 are fixedly arranged on the base 21. The rotating permanent magnet 33 is arranged on one side of the coil 312, and the permanent magnet 33 is arranged on a rotating shaft and rotate around the rotating shaft 331. There are two armatures 34, which are respectively arranged on both sides of the permanent magnet 33. One end of each armature 34 is connected to one end of the permanent magnet 33, and the other end is connected to the push card 400. One end of the push card 400 is connected to the pressure spring 16 of the contact piece structure 100. The armature 34 may be integrally formed with the permanent magnet 33. The permanent magnet 33 may also be called a magnetic steel.

When a positive pulse voltage is applied to the coil 312, the coil 312, the yoke assembly 32 and the permanent magnet 33 form a magnetic field, and the permanent magnet 33 rotates around the rotating shaft 332 and is maintained at a first rotation position. The armature 34 rotates accordingly and is maintained at the first rotation position along with the permanent magnet 33. The armature 34 drives the push card 400 to move, and the push card 400 drives the pressure spring 16 to move, so that the movable contacts 12, 12′ of the contact piece structure 100 are in contact with the static contacts 13′, 13. When the positive pulse voltage is removed, since the magnetism of the permanent magnet 33 still exists, the movable contacts 12, 12′ and the static contacts 13′, 13 may be kept contact for a long time.

When a reverse pulse voltage is applied to the coil 312, the coil 312, the yoke assembly 32 and the permanent magnet 33 form a magnetic field opposite to the magnetic field formed by the above-mentioned forward pulse voltage, and the permanent magnet 33 revolves around the rotating Shaft 331 rotates in the opposite direction and remains in a second rotational position. The armature 34 rotates accordingly and remains in the second rotation position with the permanent magnet 33. The armature 34 drives the push card 400 to move, and the push card 400 drives the pressure spring 16 to move, causing the movable contacts 12 and 12′ of the contact piece structure 100 to disconnect from the static contacts 13′ and 13. When the reverse pulse voltage is removed, since the magnetism of the permanent magnet 33 still exists, the movable contact 12, 12′ and the static contact 13′, 13 may be kept disconnected for a long time until the forward pulse voltage is applied again. The movable contact 12, 12′ and the static contact 13′, 13 contact with each other.

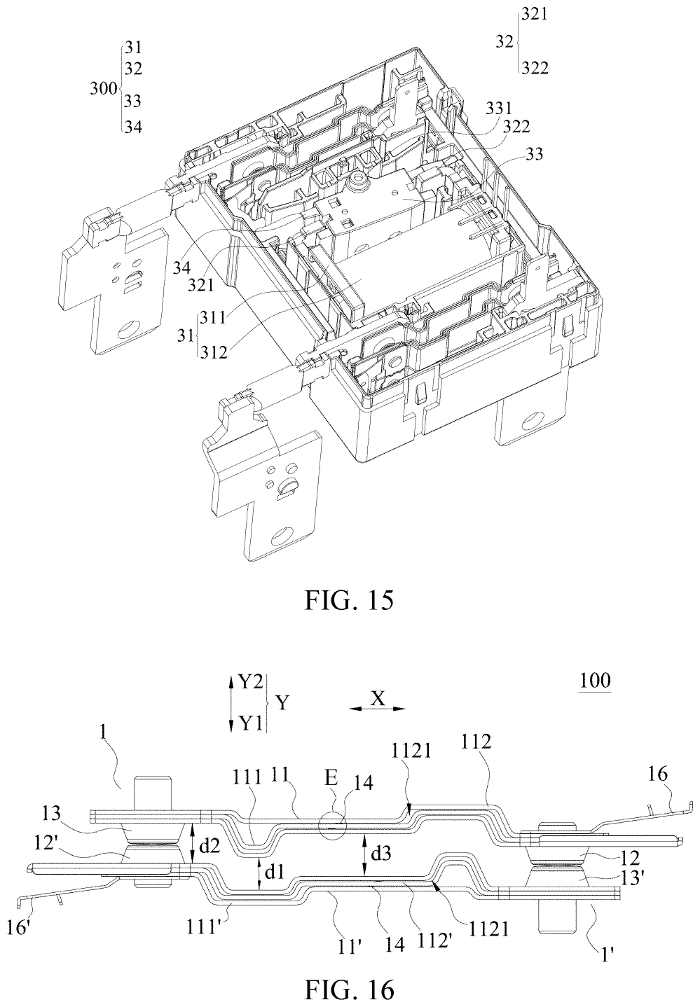

In some embodiments, as shown in FIG. 13 and FIG. 15, the magnetic latching relay may include two sets of the contact piece structures 100. The two sets of the contact piece structures 100 are arranged on both sides of the coil 312, and the pressure springs 16, 16′ of each group of the contact piece structures 100 are connected to the push card 400, so that the movable contacts 12, 12′ and the static contacts 13′, 13 of the two groups of the contact piece structures 100 may be contact and disconnected at the same time, so that the connection and disconnection states of the two sets of the contact piece structures 100 are the same, which is convenient for control. By providing two sets of the contact piece structures 100, the number of lead-out terminals of the magnetic latching relay may be increased, so that the magnetic latching relay may be connected to more loads, and the utilization rate of the magnetic latching relay is improved.

Of course, in some embodiments, the magnetic latching relay may also be provided with more sets of the contact piece structures 100, such as three sets, four sets, five sets, etc. Those skilled in the art may make settings according to actual needs and conditions, and no special limitation is made here.

Since the contact piece structure 100 adopts the contact piece structure 100 described in any of the above embodiments, the specific structure of the contact piece structure 100 may refer to the description of any of the above embodiments, and will not be repeated here.

In summary, the magnetic latching relay of the embodiment of the present disclosure is provided with the contact piece structure 100 in any of the above embodiments, the bending pair is provided with the piece body 11, 11′. The first distance d1 of the two bending pairs in each bending pair of is less than the second distance d2 at both ends of the two piece bodies 11, 11′, which reduces the distance between the two piece bodies 11, 11′. Between the two the movable contact piece 1, In the parallel circuit structure formed by 1′, currents attract each other in the same direction to generate electrodynamic force. Therefore, when the distance between the two piece bodies 11 and 11′ is reduced, the distance between the two piece bodies 11 and 11′ may be increased. At the same time, the top ends of the two bending portions of each bending pair are parallel, reducing the horizontal component of the electric force. At the same time, the bending portion may increase the effective length of the piece body 11, 11′, further increasing the electric force of the piece body 11, 11′, which may effectively increase the contact pressure between the movable contact 12, 12′ and the static contact 13, 13′, making the movable contact 12, 12′ and the static contact 13, 13′ difficult to disconnect and effectively resisting short-circuit current.

In addition, in the related art, due to the different rigidities of the spring pieces, when the spring pieces are powered on, currents in the same direction attract each other and the spring pieces are subjected to electric force and deformed. If the deformation is large, two ends of the spring piece will tend to warp up, thereby reducing the contact pressure between the movable contact and static contact, and cannot effectively resist the short-circuit current. At the same time, the magnitude of the electric force exerted on the piece cannot be adjusted according to the size of the short-circuit current.

Embodiments of the present disclosure also provide a contact piece structure and a magnetic latching relay, which may effectively increase the contact pressure between the movable contact and the static contact, thereby effectively resisting short-circuit current, and the magnitude of the electric force exerted on the piece can be flexibly adjusted.

According to one aspect of the present disclosure, a contact piece structure includes two movable contact pieces arranged side by side, each movable contact piece includes:
a piece body including a plurality of stacked spring pieces, with the gap between adjacent spring pieces;
a movable contact and a static contact arranged at opposite ends of the piece body; the movable contact and the static contact of one of the movable contact pieces correspond to the static contact and the movable contact of another movable contact piece respectively, so that when the movable contact and the static contact are in contact, the two movable contact pieces form a parallel circuit structure;
at least one movable contact piece also includes:
a bump located in the gap and connected to at least one spring piece.

In some embodiments of the present disclosure, there are a plurality of bumps, and the plurality of bumps are arranged in the gap of the plurality of spring pieces of at least one piece body;

### Wherein in a Piece Body:

the bumps are aligned in the protruding direction; or,
the bumps are offset in the protruding direction; or,
a part of the bumps are aligned in the protruding direction.

In some embodiments of the present disclosure, the bumps are provided in the gaps of the plurality of spring pieces of the two piece bodies.

In some embodiments of the present disclosure, the number of the bumps provided on the two piece bodies is the same or different.

In some embodiments of the present disclosure, the bumps provided on the two piece bodies are aligned or staggered in the protruding direction.

In some embodiments of the present disclosure, the bumps are only provided in the gap of the plurality of spring pieces of one of the piece bodies.

In some embodiments of the present disclosure, in the protruding direction, the size of the bump is less than or equal to the size of the gap.

In some embodiments of the present disclosure, each of the piece bodies has at least one bending portion, and the two bending portions of two piece bodies correspond one to one to form a bending pair; the two bending portions in each bending pair protrude along the protruding direction;
the bump is located in the gap of at least one piece body between adjacent bending pairs.

In some embodiments of the present disclosure, the piece body has a plurality of gaps, and the sizes of the gaps are different.

According to another aspect of the present disclosure, a magnetic latching relay includes the contact piece structure of the present disclosure.

It may be seen from the above technical solutions that the present disclosure has at least one of the following advantages and positive effects:

The bump is disposed in the gap of the stacked spring piece. When the spring piece is powered on, the bump may resist the deformation of the spring piece to reduce the deformation amount of the spring piece, so that the electric force received by the spring piece may be transmitted to the movable and static contacts, increasing the contact pressure between the movable and static contacts, effectively resisting short-circuit current. At the same time, the size of the short-circuit current may be obtained according to the using environment, and the size and quantity of the bump may be flexibly adjusted to control the deformation of the spring piece to avoid the contact pressure between the movable and static contacts being too large or too small.

Specific embodiments of the present disclosure are described in detail below.

The embodiment of the present disclosure provides a contact piece structure 100, as shown in FIG. 16, the contact piece structure 100 includes: two parallel movable contact pieces 1, 1′ (two parallel movable contact pieces 1, 1′arranged side by side), and the two movable contact pieces 1, 1′ have the same structure. Each movable contact piece 1, 1′ includes a piece body 11, 11′, a movable contact 12, 12′ and a static contact 13, 13′. Taking the movable contact piece structure 1 as an example, the piece body 11 includes a plurality of stacked spring pieces 112, and there is a gap 1121 between adjacent spring pieces 112. The movable contact 12 and the static contact 13 are arranged at opposite ends of the piece body 11. The movable contact 12 and the static contact 13 of one of the movable contact pieces 1 correspond to the static contact 13′ and the movable contact 12′ of the other movable contact piece 1′, respectively, so that when the movable contacts 12, 12′ and the static contacts 13′, 13′ are in contact, the two movable contact pieces 1, 1′ form a parallel circuit structure. At least one of the movable contact pieces 1, 1′ further includes a bump 14, which is disposed in the gap 1121 and connected to at least one of the spring pieces 112, 112′.

In the contact piece structure 100 of the embodiment of the present disclosure, the bump 14 is disposed in the gap 1121 of the stacked spring piece 112,112′. When the spring piece 112, 112′ is powered on, the bump 14 may resist the deformation of the spring piece 112,112′, so as to reduce the deformation amount of the spring piece 112, 112′, so that the electric force exerted on the spring piece 112,112′ may be further transmitted to the movable and static contacts, increasing the contact pressure between the movable and static contacts, effectively resisting short-circuit current. At the same time, the size of the short-circuit current may be obtained according to the use environment, and the size and quantity of the bumps 14 may be flexibly adjusted to control the deformation of the spring piece 112, 112′ so as to avoid the contact pressure between the movable and static contacts too big or too small.

The contact piece structure 100 of this embodiment of the present disclosure is described in detail below.

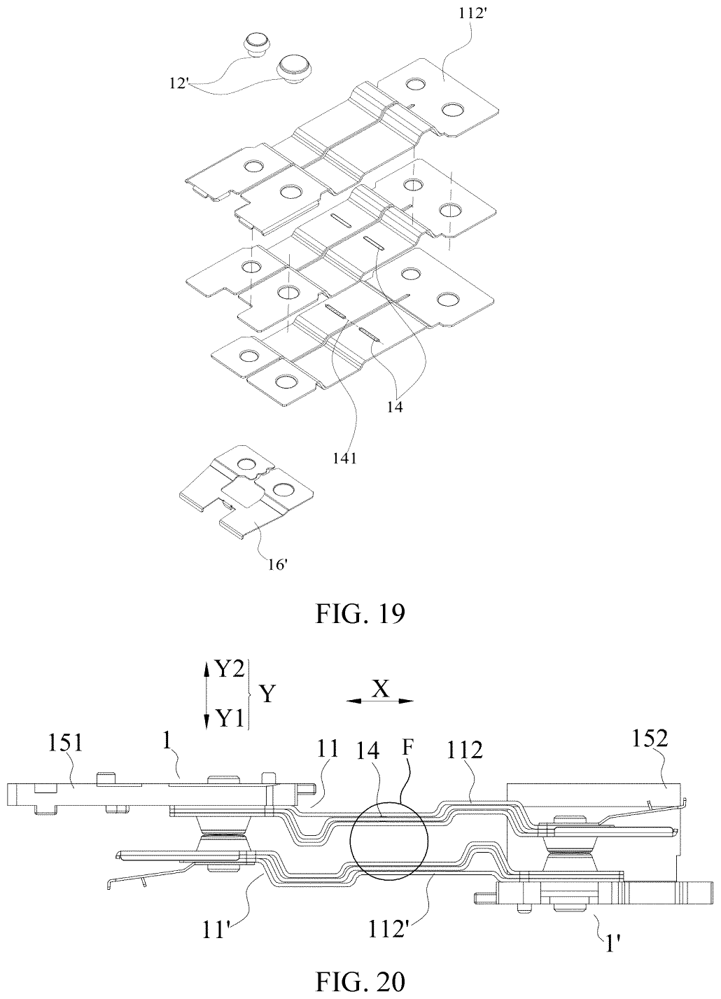

In some embodiments, as shown in FIGS. 16 to 19, taking the movable contact piece 1 as an example, the spring piece 1 includes a plurality of stacked spring pieces 112. There are gaps 1121 between adjacent spring pieces 112. That is to say, the plurality of the gaps 1121 have different sizes in the protruding direction Y. The gaps 1121 between the plurality of spring pieces 112 of the piece body 11 are located between the two ends of the piece body 11 provided with the movable contact 12 and the static contact 13. The movable contact 12 and the static contact 13 may pass through the two ends of the plurality of stacked spring pieces 112 respectively, so that the movable contacts 12, 12′ and the static contacts 13′, 13 of the two piece bodies 11, 11′ may contact each other. Wherein the protruding direction Y is the direction perpendicular to the surface of the spring piece 112 and 112′.

When the two movable contact pieces 1, 1′ are powered on, the movable contact 12 and the static contact 13′ are in contact, the movable contact 12′ is in contact with the static contact 13, and the two movable contact pieces 1, 1′ form a parallel circuit structure, and the directions of the current flowing through the two piece bodies 11 and 11′ are same. According to the principle of mutual attraction of currents in the same direction, the two piece bodies 11 and 11′ generate electric force and will definitely attract each other. By arranging the gaps 1121 between the plurality of spring pieces 112, when the spring pieces 112 are deformed by electric force, the deformations will not affect with each other, thereby ensuring the stability of the electric force.

In fact, the electromotive force is formed by the Ampere force (Lorentz force). The two movable contact pieces 1, 1′ may be regarded as two parallel wires. When the movable contact pieces 1, 1′ are energized, the two piece bodies 11, 11′ generate a magnetic field around them. Due to the action of the current and the magnetic field, one of the piece bodies 11 is subjected to the Ampere force of the other piece body 11′, so that the two attract each other. The mutual attraction between the two may increase the contact pressure of the movable contacts 12, 12′ and the static contacts 13′, 13 at both ends, making the contact between the two more firm.

If the spring piece 112 has a certain degree of flexibility, when the spring piece 112 is subjected to electric force, the spring piece 112 will use its middle part as a fulcrum to bend in the direction in which the other spring piece 112′ is approaching, because the deformation amount in the middle part is large, which may cause the parts at both ends of the spring piece 112 to warp up in opposite directions, which will tend to reduce the contact pressure between the movable contact 12 and the static contact 13′. In the embodiment of the present disclosure, the bumps 14 are disposed in the gap 1121. When the spring pieces 112 and 112′ are deformed by the electric force, the bumps 14 may resist the deformed parts of the spring pieces 112 and 112′, and that is to say, the bumps 14 may reduce the deformation amount of the spring piece 112, 112′. When the spring piece 112, 112′ is flexible, the bumps 14 may prevent the deformation amount of the spring piece 112, 112′ from being too large. As a result, the two ends of the spring piece 112, 112′ are partially warped up, thereby ensuring the stability of the contact pressure between the movable contact 12, 12′ and the static contact 13′, 13, and preventing the movable contact 12, 12′ and the static contact 13′, 13 are disconnected when subjected to the repulsive force generated by the short-circuit current.

Wherein the bumps 14 may be connected to the spring piece 112 (taking the spring piece 112 as an example) by welding, screwing or gluing. One side of the bumps 14 may be connected to a spring piece 112. Alternatively, the opposite sides of the bumps 14 may be connected to two adjacent upper and lower spring pieces 112, or the bumps 14 and the spring piece 112 may be integrally formed. The material of the bumps 14 may be the same or different from the material of the spring piece 112. The bumps 14 may be made of conductive metal or insulating material. In addition, the bumps 14 may have greater rigidity and may play a greater role in resisting the deformed spring piece 112 and prevent it from deforming. Of course, the bumps 14 may have a certain degree of flexibility. When the spring piece 112 is deformed by electric force, the bumps 14 may play a buffering role when it abuts against another spring piece 112, extending service life of the spring piece 112. The relationship between the bumps 14 and the spring piece 112′ is the same as above and will not be repeated here.

Regarding the connection method and properties of the bumps 14, those skilled in the art may select according to actual conditions, and no special limitation is made here.

In some embodiments, as shown in FIG. 16 and FIG. 19 to FIG. 25, there are a plurality of bumps 14, and the plurality of bumps 14 are arranged in the gap 1121 of the spring piece 112, 112′ of at least one of the piece body 11, 11′. In one of the piece bodies 11, the bumps 14 are aligned in the protruding direction Y, or the bumps 14 are staggered in the protruding direction Y, or part of the bumps 14 are aligned in the protruding direction Y, and another part of the bumps 14 are staggered in the protruding direction Y.

Wherein the plurality of bumps 14 may be aligned in the protruding direction Y, which may be understood that in the extension direction of the bump 14, the central line 141 of the bump 14 is aligned in the protruding direction Y. When the spring pieces 112, 112′ have high flexibility, as shown in FIG. 9, the plurality of bumps 14 may be provided in each of the gaps 1121 of the plurality of spring pieces 112, 112′, and are located at the portion that are easily deformed (such as the straight part between two adjacent bending pairs). The bump 14′ is aligned in the protruding direction Y may minimize the deformation of this part. When the piece body 11, 11′ has less flexibility, the plurality of bumps 14 may be disposed in one gap 1121, and the plurality of bumps 14 are disposed along the horizontal direction X in one gap 1121, that is, the plurality of bumps 14 are staggered in the protruding direction Y, thus, the spring pieces 112, 112′ may be deformed evenly or not deformed when receiving electric force. Taking the spring piece 112 as an example, according to the deformation of the spring piece 112, the plurality of bumps 14 may also be disposed in plurality of gaps 1121 of each spring piece 112, and the plurality of bumps 14 may be disposed in each gap 1121. A bump of 14 may be disposed by those skilled in the art according to the actual situation, and there is no special limitation here.

Of course, in order to save costs and simplify the manufacturing process, the number of the bumps 14 is as small as possible when the number and location of the bumps 14 meet the deformation requirements of the spring piece 112. The horizontal direction X may be defined as the extension direction of the spring piece 112, which is perpendicular to the protruding direction Y.

In some embodiments, as shown in FIG. 16, the bumps 14 are provided on gaps 1121 of the plurality of spring pieces 112, 112′ of two piece bodies 11, 11′.

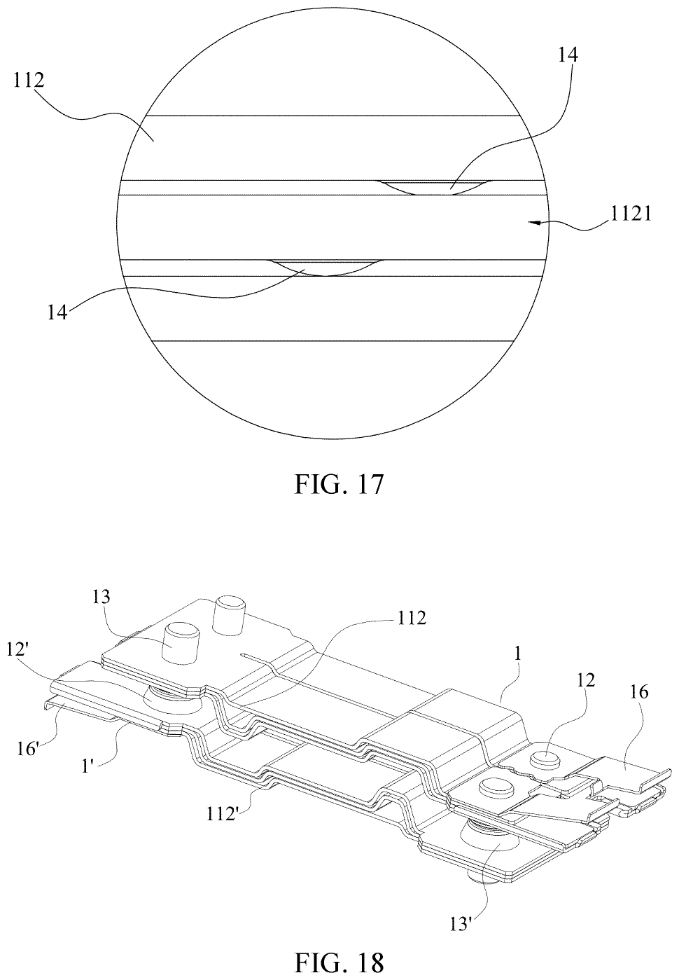

Based on the above embodiment, as shown in FIGS. 16 and 17, the bump 14 may be disposed in the gaps 1121 of the plurality of the spring pieces 112, 112′ of the piece bodies 11, 11′ of the two movable contact pieces 1, 1′. In some embodiments, the number of the bump 14 disposed in the two piece bodies 11, 11′ is the same or different, and the positions of the bumps 14 of the two piece bodies 11, 11′ may be the same or different. In some embodiments, in order to simplify the manufacturing process, the number and positions of the bumps 14 set disposed in two piece bodies 11, 11′ are the same. Those skilled in the art may set it according to actual conditions, and no special limitation is made here.

In some embodiments, as shown in FIGS. 16 and 24, the bumps 14 provided on two piece bodies 11, 11′ are aligned or staggered in the protruding direction Y. The central line 141 of the bump 14 located in the two piece bodies 11, 11′ may be aligned in the protruding direction Y, or may be staggered. Persons skilled in the art may set it according to the actual situation of the spring pieces 112, 112′, no special restrictions are made here.

In some embodiments, as shown in FIGS. 20 to 23, the bumps 14 are only provided in the gaps 1121 of the plurality of the spring pieces 112, 112′ of one of the piece bodies 11, 11′. That is, he bumps 14 may be provided in only one of the piece bodies 11. For example, the spring piece 112 of the piece body 11 has greater flexibility, and by providing the bump 14, it may be prevented from having a greater amount of deformation.

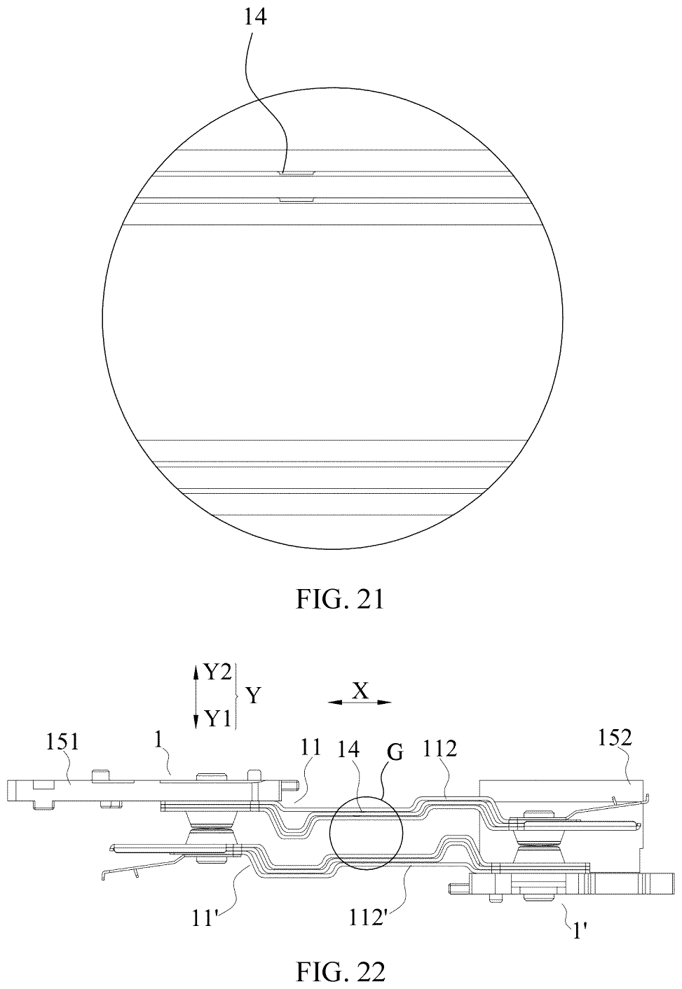

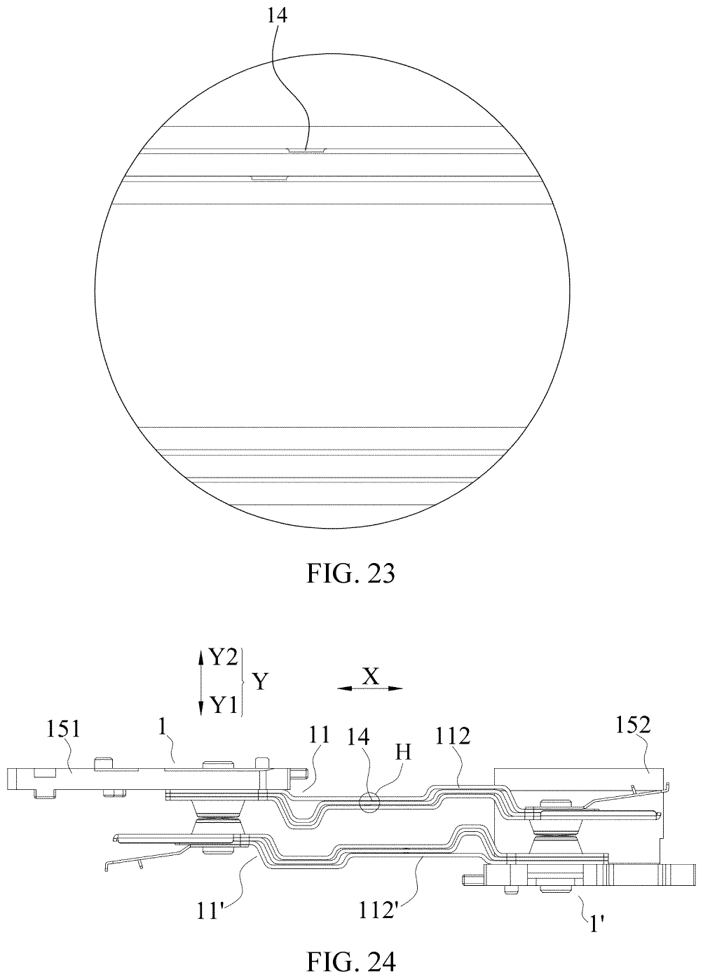

In some embodiments, as shown in FIG. 21, FIG. 23 and FIG. 10, in the protruding direction Y, the size of the bump 14 is less than or equal to the size of the gap 1121.

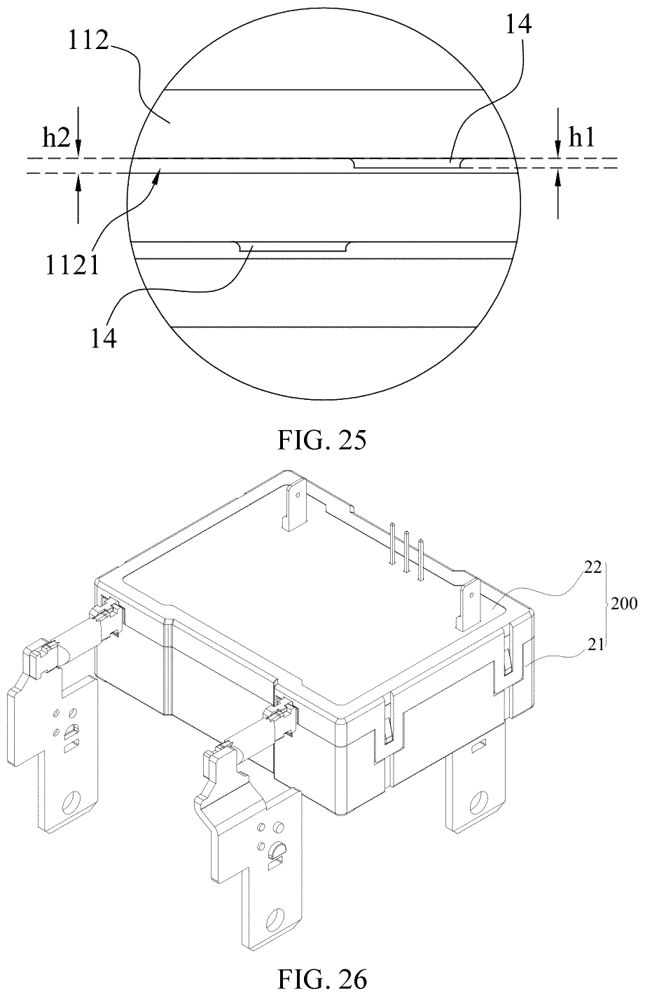

Specifically, as shown in FIG. 25, in the protruding direction Y, the size h1 of the bump 14 is smaller than the size h2 of the gap 1121. Taking the spring piece 112 as an example, one side of the bump 14 is connected to the spring piece 112, and the other side has a gap with the adjacent spring piece 112. When the spring piece 112 is subjected to electric force, the bump 14 does not immediately press against the other spring piece 112, but allows the spring piece 112 to have a certain amount of deformation before preventing deformation. In this case, the spring piece 112 may have an overtravel, thereby increasing the contact pressure between the movable contact 12 and the static contact 13′ of the other piece body 11′. According to the deformation ability of the spring piece 112, the size h1 of the bump 14 in the protruding direction Y may be appropriately adjusted, and then the size of the gap between the bump 14 and the adjacent spring piece 112 may be adjusted, so as to flexibly adjust the deformation of the spring piece 112 so that the contact pressure between the movable contact 12 and the static contact 13′ reaches the most appropriate value. The specific size of the bump 14 in the protruding direction Y may be set according to actual conditions, such as the deformation of the spring piece 112, the size of the short-circuit current, etc., and is not specifically limited here.

Therefore, according to the magnitude of the short-circuit current, the size, quantity, position, etc. of the bump 14 may be changed, and the magnitude of the electric force applied to the spring piece 112, 112′ may be flexibly adjusted to avoid the contact pressure between the movable contact 12, 12′ and the static contact 13′, 13 being too large or too small.

In some embodiments, as shown in FIGS. 16 and 18 to 19, each of the piece bodies 11, 11′ has at least one bending portion, and the bending portions of two of the piece bodies 11, 11′ are arranged in a one-to-one correspondence to form a bending pair; in each bending pair, the two bending portions protrude along the protruding direction Y; the bump 14 is arranged in the gap of at least one of the piece bodies 11, 11′ between adjacent bending pairs.

As shown in FIG. 16, the bending portion is formed by bending the piece body 11, and the bending portion may protrude along the protruding direction Y. The protruding direction Y may include the first direction Y1 and the second direction Y2 which are opposite to each other. When there is one bending pair, the bending pair may protrude toward the first direction Y1 or the second direction Y2. When there are a plurality of bending pairs, the plurality of bending pairs may all protrude toward the first direction Y1, or may all protrude toward the second direction Y2, or some of the bending pairs may protrude toward the first direction Y1, and another part of the bending pairs may protrude toward the second direction Y2, which is not particularly limited here.

Bending portions in the bending pair are the first bending portion 111 and the second bending portion 11′, and at least part of the first bending portion 111 is accommodated in the space formed by the protruding portion of the second bending portion 111′ (not shown in the figure), so that the first distance d1 of the two bending portions in each bending pair is less than the second distance d2 of the two ends of the two piece bodies 11, 11′.

When the two movable contact pieces 1, 1′ are energized, the movable contact 12 is in contact with the static contact 13′, the movable contact 12′ is in contact with the static contact 13′, the two movable contact pieces 1, 1′ form a parallel circuit structure, and the directions of the currents flowing through the two piece bodies 11, 11′ are the same. According to the principle that currents with the same direction attract each other, the two piece bodies 11, 11′ attract each other, and the first distance d1 of the two piece bodies 11 and 11′ is reduced at the bending portion, which increases the electromotive force of the two piece bodies 11, 11′ attracting each other. At the same time, the bending portion may increase the effective length of the piece bodies 11, 11′, thereby increasing the contact pressure between the movable contacts 12, 12′ and the static contacts 13′, 13, thereby preventing the movable contacts 12, 12′ and the static contacts 13′, 13 from being disconnected when subjected to the repulsive force of the short-circuit current, thereby resisting the short-circuit current and ensuring the stability of the circuit.

In some embodiments, the top ends of the two bending portions in each bending pair are parallel. The bending portion may be any one of a trapezoid, a rectangle, a square and a polygon. In this way, the electric forces received by the two bending portions are respectively perpendicular to themselves, and no oblique electric forces are generated, thereby reducing the component of the electric forces along the horizontal direction X and increasing the electric forces received by each of the piece bodies 11, 11′. Continuing to refer to FIG. 16, the side walls of the plurality of bending portions are also parallel to each other, so that the force of attraction between the two piece bodies 11, 11′ reaches the maximum, further increasing the electric forces.

In some embodiments, as shown in FIG. 16 and FIG. 17, the piece body 11, 11′ respectively have a plurality of the gaps 1121, and the sizes h2 of the plurality of the gaps 1121 are different. In other words, the plurality of gaps 1121 have different sizes in the protruding direction Y. Therefore, the gaps 1121 may be provided with different sizes of the bumps 14.

By setting the gaps 1121 between the plurality of spring pieces 112,112′, when each spring piece 112 is deformed by electrodynamic force, the deformation of each spring piece 112 will not affect another, thereby the stability of the electrodynamic force is received. In addition, according to the value of the short-circuit current, the number, position, size of the bumps 14, the number of the bending pairs, the bending degree of the bending portion, or the first change between the bending portions in each bending pair may be changed. The distance d1 may flexibly adjust the magnitude of the electric force received by the spring piece 112 and 112′. Wherein, the bending degree of the bending portion may be understood as the size from the top wall of the bending portion along the protruding direction Y to the opening.

In some embodiments, the bump 14 is connected to the position of the spring piece with the maximum deformation. The maximum deformation position refers to the position where the deformation amount of the spring piece 112, 112′ is the largest after the contact piece structure 100 is powered on. In some embodiments, the bumps 14 are located in the gaps 1121 between the plurality of spring pieces 112, 112′ in the straight parts between the two adjacent bending pairs of the piece body 11, 11′. The bumps 14 are arranged at the position of the spring piece 112, 112′ with the maximum deformation, which may prevent the spring piece 112, 112′ from being excessively deformed, so as to ensure the stability of the electric force.

In some embodiments, as shown in FIG. 20, FIG. 22 and FIG. 24, each of the movable contact pieces 1 in the contact piece structure 100 further includes a first movable contact leading-out piece 151 and a second movable contact leading-out piece 152. One end of the first movable contact leading-out piece 151 is connected to the static contact 13, and the other end is used for connecting to an external load. One end of the second movable contact leading-out piece 152 is connected to the static contact 13′, and the other end is used to connect to an external load.

In some embodiments, as shown in FIG. 16, the movable contact piece 1, 1′ of the contact piece structure 100 further includes a pressure spring 16, 16′. Taking the movable contact piece 1 as an example, one end of the pressure spring 16 is connected to the movable contact 12, and the other end is used to connect to the push card 400 of the magnetic latching relay.

The bumps 14 are disposed in the gap 1121 of the stacked spring piece 112, 112′. When a current flows through the spring piece 112 and 112, the bumps 14 can resist the deformation of the spring pieces 112 and reduce the deformation amount of the spring pieces 112 and 112, so that the electric force received by the spring pieces 112 and 112 may be further transmitted to the movable and static contacts, thereby increasing the contact pressure between the movable and static contacts and effectively resisting short-circuit current. At the same time, the size of the short-circuit current may be obtained according to the using environment, and the size and quantity of the bumps 14 may be flexibly adjusted to control the deformation amount of the spring pieces 112 and 112 to avoid contact pressure between the movable and static contacts being too large or too small.

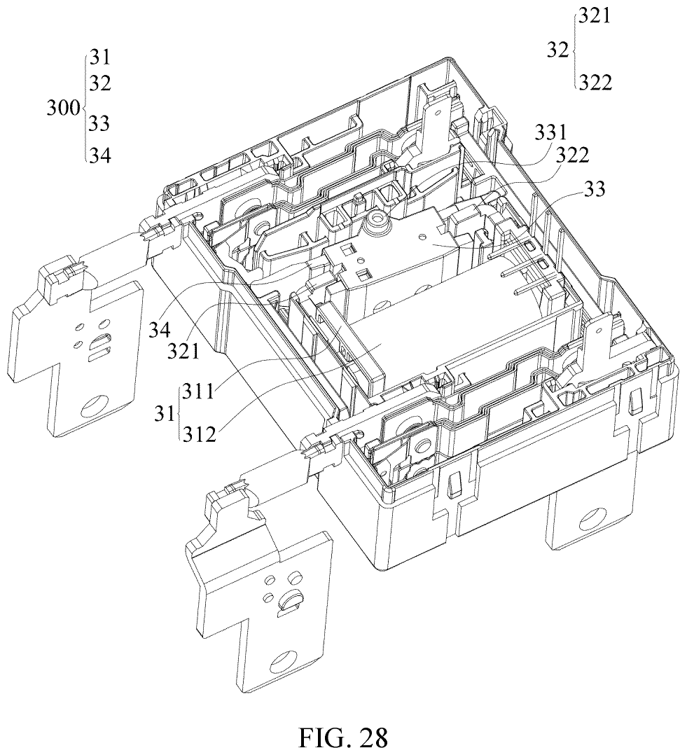

As shown in FIGS. 26 to 28, the embodiment of the present disclosure also provides a magnetic latching relay including a shell 200 and at least one contact piece structure 100 described in any of the above embodiments, a magnetic circuit structure 300, a push card 400 and a fixed frame 500.

As shown in FIG. 26, the shell 200 includes a base 21 and a cover 22. The contact piece structure 100 and the magnetic circuit structure 300 are both mounted on the base 21, the fixed frame 500 is mounted on the magnetic circuit structure 300, and the cover 22 is covered, so that the contact piece structure 100, the magnetic circuit structure 300, the push card 400 and the fixed frame 500 may be accommodated in the shell 200.

In some embodiments, the magnetic circuit structure 300 includes a coil assembly 31, a yoke assembly 32, a rotating permanent magnet 33 and an armature 34. The coil assembly 31 includes a bobbin 311 and a coil 312, and the coil 312 is wound around the bobbin 311. The yoke assembly 32 includes a first yoke 321 and a second yoke 322. The first yoke 321 and the second yoke 322 are located on both sides of the bobbin 311 in the axial direction, and the first yoke 321 and the second yoke 322 are fixedly arranged on the base 21. The rotating permanent magnet 33 is arranged on one side of the coil 312, and the permanent magnet 33 is arranged on a rotating shaft and rotate around the rotating shaft 331. There are two armatures 34, which are respectively arranged on both sides of the permanent magnet 33. One end of each armature 34 is connected to one end of the permanent magnet 33, and the other end is connected to the push card 400. One end of the push card 400 is connected to the pressure spring 16 of the contact piece structure 100. The armature 34 may be integrally formed with the permanent magnet 33. The permanent magnet 33 may also be called a magnetic steel.

When a positive pulse voltage is applied to the coil 312, the coil 312, the yoke assembly 32 and the permanent magnet 33 form a magnetic field, and the permanent magnet 33 rotates around the rotating shaft 332 and is maintained at a first rotation position. The armature 34 rotates accordingly and is maintained at the first rotation position along with the permanent magnet 33. The armature 34 drives the push card 400 to move, and the push card 400 drives the pressure spring 16 to move, so that the movable contacts 12, 12′ of the contact piece structure 100 are in contact with the static contacts 13′, 13. When the positive pulse voltage is removed, since the magnetism of the permanent magnet 33 still exists, the movable contacts 12, 12′ and the static contacts 13′, 13 may be kept contact for a long time.

When a reverse pulse voltage is applied to the coil 312, the coil 312, the yoke assembly 32 and the permanent magnet 33 form a magnetic field opposite to the magnetic field formed by the above-mentioned forward pulse voltage, and the permanent magnet 33 revolves around the rotating Shaft 331 rotates in the opposite direction and remains in a second rotational position. The armature 34 rotates accordingly and remains in the second rotation position with the permanent magnet 33. The armature 34 drives the push card 400 to move, and the push card 400 drives the pressure spring 16 to move, causing the movable contacts 12 and 12′ of the contact piece structure 100 to disconnect from the static contacts 13′ and 13. When the reverse pulse voltage is removed, since the magnetism of the permanent magnet 33 still exists, the movable contact 12, 12′ and the static contact 13′, 13 may be kept disconnected for a long time until the forward pulse voltage is applied again. The movable contact 12, 12′ and the static contact 13′, 13 contact with each other.

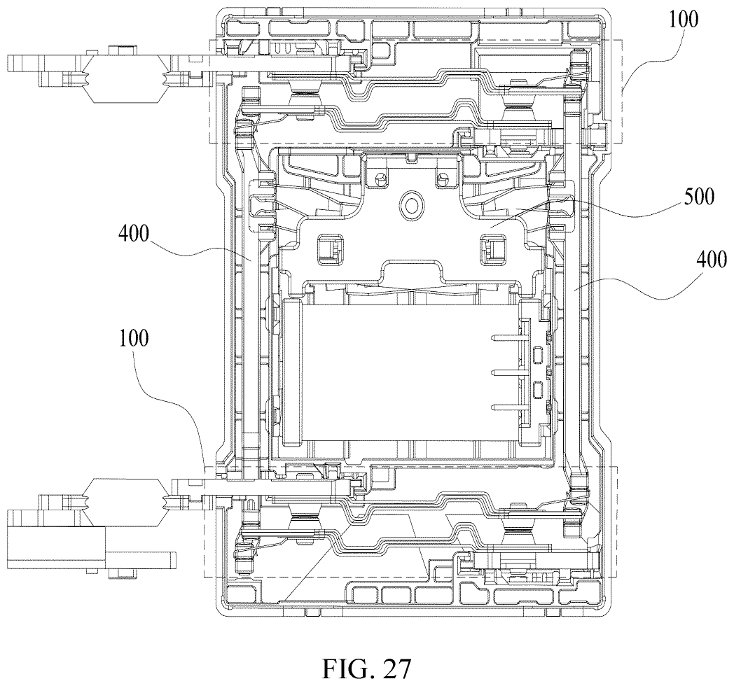

In some embodiments, as shown in FIG. 27, the magnetic latching relay may include two sets of the contact piece structures 100. The two sets of the contact piece structures 100 are arranged on both sides of the coil 312, and the pressure springs 16, 16′ of each group of the contact piece structures 100 are connected to the push card 400, so that the movable contacts 12, 12′ and the static contacts 13′, 13 of the two groups of the contact piece structures 100 may be contact and disconnected at the same time, so that the connection and disconnection states of the two sets of the contact piece structures 100 are the same, which is convenient for control. By providing two sets of the contact piece structures 100, the number of lead-out terminals of the magnetic latching relay may be increased, so that the magnetic latching relay may be connected to more loads, and the utilization rate of the magnetic latching relay is improved.

Of course, in some embodiments, the magnetic latching relay may also be provided with more sets of the contact piece structures 100, such as three sets, four sets, five sets, etc. Those skilled in the art may make settings according to actual needs and conditions, and no special limitation is made here.

Since the contact piece structure 100 adopts the contact piece structure 100 described in any of the above embodiments, the specific structure of the contact piece structure 100 may refer to the description of any of the above embodiments, and will not be repeated here.

In summary, the magnetic latching relay of the embodiment of the present disclosure, the bumps 14 are disposed in the gaps 1121 of the stacked spring pieces 112 and 112′. When the current flows through the spring pieces 112 and 112, the bumps 14 may resist the deformation of the spring pieces 112 and 112 to reduce the deformation amount of the spring pieces 112 and 112, so that the electric force received by the spring pieces 112 and 112 may be further transmitted to the movable and static contacts, increasing the contact pressure between the movable and static contacts, and effectively resisting short-circuit current. At the same time, the value of the short-circuit current may be obtained according to the using environment, and the size and quantity of the bumps 14 may be flexibly adjusted to control the deformation amount of the spring pieces 112 and 112 to avoid the contact pressure between the movable and static contacts. being too large or too small.

It may be understood that the various embodiments/implementations provided by the present disclosure may be combined with each other without causing conflicts, and examples will not be given one-to-one here.

In the embodiment of the present disclosure, the terms “first”, “second” and “third” are only used for description purposes and cannot be understood as indicating or implying relative importance; the term “plurality” refers to two or Two or more, unless otherwise expressly limited. The terms “installation”, “connection”, “connection” and “fixing” should be understood in a broad sense. For example, “connection” may be a fixed connection, a detachable connection, or an integral connection; “connection” may be Either directly or indirectly through an intermediary. For those of ordinary skill in the art, the specific meanings of the above terms in the embodiments of the present disclosure may be understood according to specific circumstances.

In the description of the embodiments of the present disclosure, it should be understood that the directions or positional relationships indicated by the terms “upper”, “lower”, “left”, “right”, “front”, “back”, etc. are based on those shown in the accompanying drawings. The orientation or positional relationship is only for the convenience of describing the embodiments of the present disclosure and simplifying the description. It does not indicate or imply that the device or unit referred to must have a specific direction, be constructed and operated in a specific orientation, and therefore, it cannot be understood as a limitation of the present disclosure. Limitations of Disclosure Embodiments.

In the description of this specification, the terms “one embodiment,” “some embodiments,” “specific embodiments,” etc., mean that a particular feature, structure, material or characteristic described in connection with the embodiment or example is included in the disclosure. In at least one embodiment or example of an embodiment. In this specification, schematic representations of the above terms do not necessarily refer to the same embodiment or example. Furthermore, the specific features, structures, materials or characteristics described may be combined in any suitable manner in any one or more embodiments or examples.

The above are only preferred embodiments of the present disclosure, and are not intended to limit the embodiments of the present disclosure. For those skilled in the art, various modifications and changes may be made to the embodiments of the present disclosure. Any modifications, equivalent substitutions, improvements, etc. made within the spirit and principles of the embodiments of the present disclosure shall be included in the protection scope of the embodiments of the present disclosure.

We claim:

1. A contact piece structure comprising two movable contact pieces arranged side by side, each movable contact piece comprising:
a piece body;
a movable contact and a static contact located at opposite ends of the piece body;
wherein the movable contact and the static contact of one of the movable contact pieces correspond to the static contact and the movable contact of the other movable contact piece respectively, so that when the movable contact and the static contact being in contact, the two movable contact pieces form a parallel circuit structure;
each piece body has at least one bending portion, and bending portions of two piece bodies are arranged one-to-one to form a bending pair; in each of the bending pairs, top ends of two bending portions are parallel with each other, and two bending portions protrude along a same protruding direction, a first distance between the two bending portions is smaller than a second distance between the two ends of two piece bodies.

2. The contact piece structure according to claim 1, wherein the two bending portions forming the bending pair are respectively a first bending portion and a second bending portion, at least a portion of the first bending portion is accommodated in a space formed by a protruding portion of the second bending portion.

3. The contact piece structure according to claim 1, wherein there are a plurality of bending pairs, and there is a third distance between the two piece bodies located between adjacent bending pairs, and the third distance is greater than the first distance.

4. The contact piece structure according to claim 2, wherein there are a plurality of bending pairs, and there is a third distance between the two piece bodies located between adjacent bending pairs, and the third distance is greater than the first distance.

5. The contact piece structure according to claim 3, wherein the protruding direction comprises a first direction and a second direction which are opposite to each other, among the plurality of the bending pairs, a part of the bending pairs protrude toward the first direction, and another part of the bending pairs protrude toward the second direction.

6. The contact piece structure according to claim 2, wherein in each of the bending pairs, a size of an opening of the second bending portion is larger than a size of a top end of the first bending portion, so that the top of the first bending portion is accommodated in the opening of the second bending portion.

7. The contact piece structure according to claim 1, wherein the shape of each of the bending portions is any one of a trapezoid, a rectangle, a square, a pentagon, a hexagon and an octagon.

8. The contact piece structure according to claim 1, wherein each piece body comprises a plurality of spring pieces stacked with each other, a gap is formed between adjacent spring pieces.

9. The contact piece structure according to claim 8, wherein the piece body has a plurality of gaps in a direction in which the spring piece is stacked, and the sizes of the gaps are different.

10. The contact piece structure according to claim 8, further comprising a bump, the bump being disposed in the gap and connected to at least one spring piece.

11. The contact piece structure according to claim 10, wherein the bump is provided in the gap of at least one piece body between adjacent bending pairs.

12. The contact piece structure according to claim 10, wherein there are a plurality of bumps, and the plurality of bumps are arranged in the gaps of the plurality of spring pieces of at least one piece body;
wherein in a piece body:
the bumps are aligned in the protruding direction; or,
the bumps are offset in the protruding direction; or,
a part of the bumps are aligned in the protruding direction.

13. The contact piece structure according to claim 11, wherein the bumps are respectively provided in the gaps of the plurality of spring pieces of the two piece bodies.

14. The contact piece structure according to claim 12, wherein the bumps are respectively provided in the gaps of the plurality of spring pieces of the two piece bodies.

15. The contact piece structure according to claim 13, wherein the number of the bumps provided on the two piece bodies are the same or different.

16. The contact piece structure according to claim 15, wherein the bumps provided on the two piece bodies are aligned or staggered in the protruding direction.

17. The contact piece structure according to claim 11, wherein the bump is provided in the gap of a plurality of spring pieces of one of the piece bodies.

18. The contact piece structure according to claim 12, wherein the bump is provided in the gap of a plurality of spring pieces of one of the piece bodies.

19. The contact piece structure according to claim 10, wherein in the protruding direction, the size of the bump is less than or equal to the size of the gap.

20. A magnetic latching relay, comprising the contact piece structure of claim 1.
